(19) United States
(12) Patent Application Publication
(10) Pub. No.: US 2006/0193600 A1
(43) Pub. Date: Aug. 31, 2006

(54) Program video-recording apparatus and method

(75) Inventor: Akira Miyazawa, Saitama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/337,500

(22) Filed: Jan. 24, 2006

(30) Foreign Application Priority Data
Feb. 28, 2005 (JP) 2005-054793

(51) Int. Cl. H04N 5/445; H04N 5/91

(52) U.S. Cl. 386/83; 725/38

(57) ABSTRACT

A program video-recording apparatus of the present invention comprises acquisition sections configured to acquire and store program information of a predetermined program being delivered, a decision section configured to decide whether a program corresponding to the program information can be video-recorded, based on the acquired program information, and a control section configured to provide display based on the program information acquired by the acquisition sections and display based on a result of decision by the decision section.

### CROSS-REFERENCE TO RELATED APPLICATIONS

This application is based upon and claims the benefit of priority from prior Japanese Patent Application No. 2005-054793, filed Feb. 28, 2005, the entire contents of which are incorporated herein by reference.

### BACKGROUND OF THE INVENTION

1. Field of the Invention

The present invention relates to an improvement of a program video-recording apparatus and method for video-recording a program being delivered or viewed.

2. Description of the Related Art

It is known that recently of digital TV broadcasting has been promoted. For example, in Japan, terrestrial digital broadcasting has started as well as digital direct broadcasting by satellite.

A digital broadcast receiver for receiving such a digital TV broadcast creates an electronic program table based on an electronic program guide (EPG) information acquired from a broadcast signal and displays it graphically on a screen. A user, in turn, can select a desired program from the graphically displayed electronic program table, to view or reserve it for video recording.

Jpn. Pat. Appln. KOKAI Publication Nos. 2001-268488 and 11-266411 both disclose a technology whereby if video-recording of a program being viewed currently is desired, a finish time of the program to be video-recorded is acquired from EPG information, to automatically stop video-recording of the program when its finish time is reached without a user stopping the video-recording.

However, taking into actual operation, to video-record a program being broadcast or viewed currently, it is important, for example, to enable the user to easily confirm program information about the program to be video-recorded or to take countermeasures, etc., if a broadcast time slot of the program to be video-recorded overlaps with that of any other program reserved for video recording.

### BRIEF SUMMARY OF THE INVENTION

According to one aspect of the present invention, there is provided a program video-recording apparatus comprising: acquisition sections configured to acquire and store program information of a predetermined program being delivered; a decision section configured to decide whether a program corresponding to the program information can be video-recorded, based on the program information acquired by the acquisition sections; and a control section configured to provide display based on the program information acquired by the acquisition sections and display based on a result of decision by the decision section.

According to another aspect of the present invention, there is provided a program video-recording method comprising: a first step of acquiring and storing program information of a predetermined program being delivered; a second step of deciding whether a. program corresponding to the program information can be video-recorded, based on the acquired program information; and a third step of providing display based on the acquired program information and display based on a result of the decision.

### BRIEF DESCRIPTION OF THE SEVERAL VIEWS OF THE DRAWING

FIG. 1 is a schematic diagram of a digital TV broadcast receiver according to one embodiment of the present invention and one example of a network system configured around this receiver;

FIG. 2 is a block diagram of an important signal processing system of the digital TV broadcast receiver of the present embodiment;

FIG. 3 is an illustration of a remote controller of the digital TV broadcast receiver of the present embodiment;

FIG. 4 is a flowchart of an operation of video-recording or selecting a channel of a program being broadcast currently, by the digital TV broadcast receiver of the present embodiment;

FIG. 5 is a view of one example of an electronic program table displayed on the digital TV broadcast receiver of the present embodiment;

FIG. 6 is a view of one example of a program specification and video-recording/channel selection screen displayed on the digital TV broadcast receiver of the present embodiment;

FIG. 7 is a view of another example of the program specification and video-recording/channel selection screen displayed on the digital TV broadcast receiver of the present embodiment;

FIG. 8 is a flowchart of an operation of video-recording a currently viewed program in the digital TV broadcast receiver of the present embodiment;

FIG. 9 is a view of one example of a program explanation screen displayed on the digital TV broadcast receiver of the present embodiment; and

FIG. 10 is a view of another example of the program explanation screen displayed on the digital TV broadcast receiver of the present embodiment.

### DETAILED DESCRIPTION OF THE INVENTION

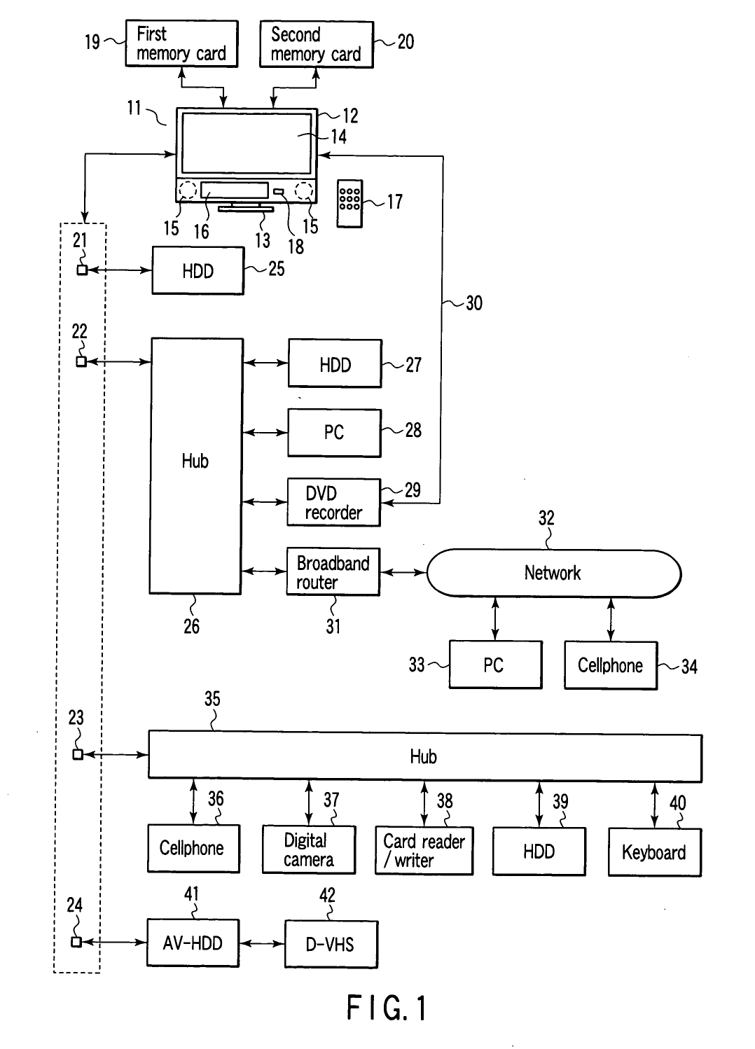

The following will describe in detail one embodiment of the present invention with reference to the drawings. FIG. 1 schematically shows an external view of a digital TV broadcast receiver 11 described in the present embodiment and one example of a network system configured around this digital TV broadcast receiver 11.

That is, the digital TV broadcast receiver 11 mainly comprises a thin cabinet 12 and a support stand 13 for erecting and supporting this cabinet 12. The cabinet 12 is mounted therein with a flat panel video display 14 constituted of, for example, an LCD panel, a speaker 15, an operation section 16, a light reception section 18 for receiving operation information transmitted from a remote controller 17, etc.

A first memory card 19 such as, for example, a Secure Digital (SD) memory card or a Multimedia Card (MMC) can be attached to and detached from this digital TV broadcast receiver 11 so that recording/playback of information such as a program, a photograph, etc., may be operated to this first memory card 19.

A second memory card (IC card) 20 having a built-in semiconductor memory in which, for example, contract information etc. is recorded can be attached to and detached from this digital TV broadcast receiver 11 so that recording/playback of information may be operated to this second memory card 20.

This digital TV broadcast receiver 11 further comprises a first local area network (LAN) terminal 21, a second LAN terminal 22, a universal serial bus (USB) terminal 23, and an i.Link (registered trademark) terminal 24.

Of these, the first LAN terminal 21 is an LAN-compliant hard disk drive (HDD) dedicated port and used to perform recording/playback of information through the Ethernet (registered trademark) to an LAN-compliant HDD25, which is connected network attached storage (NAS).

By thus providing the first LAN terminal 21 as an LAN-compliant HDD-dedicated port, it is possible to stably record information of a program with a high-definition image quality in the HDD25 without being influenced by an environment, an operating condition, etc. of any other networks.

The second LAN terminal 22, on the other hand, is a general LAN-compliant port by use of the Ethernet (registered trademark) and used to connect via, for example, a hub to an apparatus such as an LAN-compliant HDD27, a personal computer (PC) 28, or a DVD recorder 29 having a built-in HDD so that information may be transmitted to and received from these apparatuses.

It is noted that since the DVD recorder 29 exchanges only control system of digital information communicated through the second LAN terminal 22, it is necessary to provide a dedicated analog transmission path 30 so that an analog video signal and an analog audio signal may be transmitted to and received from the digital TV broadcast receiver 11.

Further, this second LAN terminal 22 is used to connect to a network 32 such as the Internet, for example, via a broadband router 31 connected to the hub 26 so that information may be transmitted to and received from a PC33, a cell phone 34, etc. through this network 32.

The above-described USB terminal 23, on the other hand, is a general USB-compliant port and used to connect via, for example, a hub 35 to a USB apparatus such as a cell phone 36, a digital camera 37, a card reader/writer 38 for a memory card, an HDD 39, or a keyboard 40 so that information may be transmitted to and received from these USB apparatuses.

Further, the above-described i.Link terminal 24 is used to connect serially to, for example, an AV-HDD41 and D (digital)-VHS (video home system) 42 and even to a ground-wave digital tuner (not shown) etc. so that information may be transmitted to and received from these apparatuses.

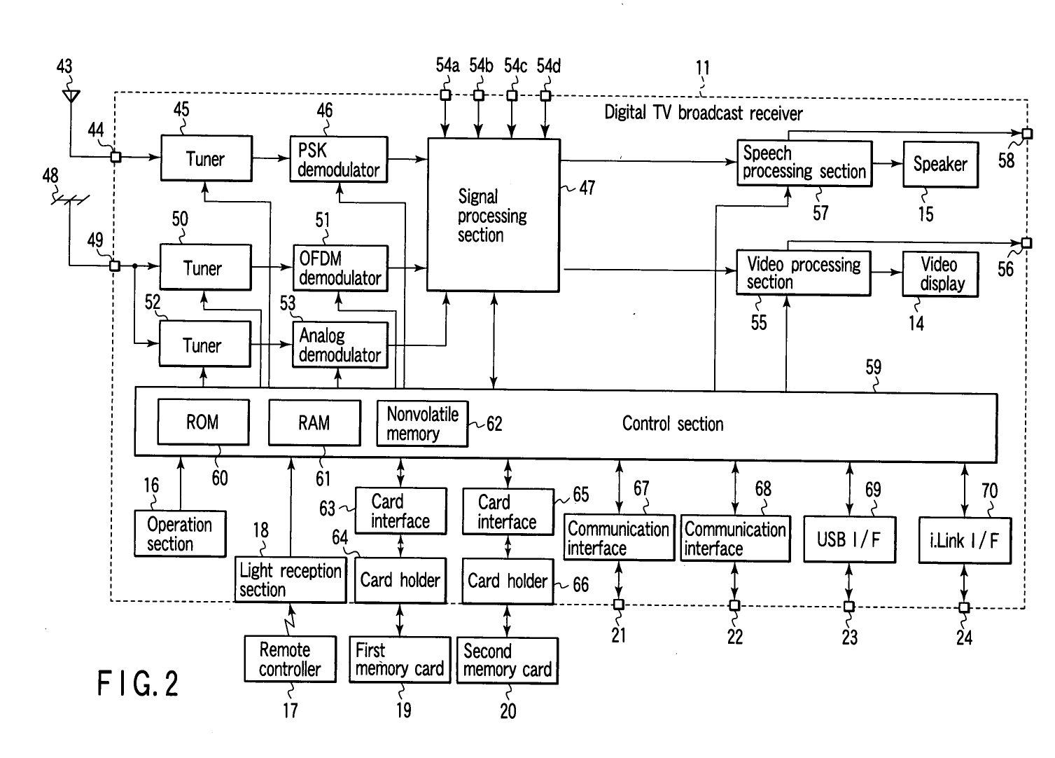

FIG. 2 shows an important signal processing system of the above-described digital TV broadcast receiver 11. That is, a satellite digital TV broadcast signal received with an antenna 43 for BS/CS digital broadcast reception is supplied via an input terminal 44 to a satellite digital broadcasting tuner 45 so that a desired channel of broadcast signal may be selected.

The broadcast signal whose channel has been thus selected by this tuner 45 is supplied to a phase shift keying (PSK) demodulator 46 to be demodulated into digital video and audio signals, which are then provided to a signal processing section 47.

On the other hand, a ground digital TV broadcast signal received with a ground-wave broadcast reception antenna 48 is supplied via an input terminal 49 to a ground digital broadcasting tuner 50 so that a desired channel of broadcast signal may be selected.

The broadcast signal whose channel has been thus selected by this tuner 50 is supplied to an orthogonal frequency division multiplexing (OFDM) demodulator 51 to be demodulated into digital video and audio signals, which are then provided to the above-described signal processing section 47.

Further, a ground analog TV broadcast signal received with the above-described ground-wave broadcast reception antenna 48 is supplied via the input terminal 49 to a ground analog broadcasting tuner 52 so that a desired channel of broadcast signal may be selected. The broadcast signal whose channel has been thus selected by this tuner 52 is supplied to an analog demodulator 53 to be demodulated into analog video and audio signals, which are then provided to the above-described signal processing system 47.

Further, to the above-described signal processing section 47, a plurality of (four in the figure) input terminals 54a, 54b, 54c, and 54d is connected. These input terminals 54a to 54d respectively enable inputting analog video and audio signals from an outside of the digital TV broadcast receiver 11.

It is to be noted that the above-described signal processing section 47 selectively conducts predetermined digital signal processing on digital video and audio signals supplied respectively from the PSK demodulator 46 and the OFDM demodulator 51.

Further, this signal processing section 47 selectively digitizes analog video and audio signals supplied respectively from the above-described analog demodulator 53 and the input terminals 54a to 54d and conducts predetermined digital signal processing on these digitized video and audio signals.

The digital signal processing conducted by this signal processing section 47 may be, for example, MPEG decoding processing on an audio signal, MPEG noise reduction processing which reduces mosquito noise generated with this MPEG decoding processing, processing to superimpose an on-screen display (OSD) signal on a video signal, scaling processing on a video signal, decoding processing on an audio signal, etc.

The digital video signal output from the signal processing section 47 is supplied to a video processing section 55. This video processing section 55 converts the input digital video signal into an analog video signal having such a format that it can be displayed on the above-described video display 14 and then outputs it to the video display 14 so that a video may be displayed and leads it to the outside through an output terminal 56.

The digital audio signal output from the signal processing section 47, on the other hand, is supplied to a speech processing section 57. This speech processing section 57 converts the input digital audio signal into an analog audio signal having such a format that it can be reproduced by the above-described speaker 15 and then outputs it to the speaker 15 so that speech may be reproduced and leads it to the outside via an output terminal 58.

It is to be noted that all of operations including the above-described variety of reception operations of this digital TV broadcast receiver 11 are totally controlled by a control section 59. This control section 59 has a built-in central processing unit (CPU) etc., to receive operation information from the above-described operation section 16 or receive through the above-described light reception section 18 operation information sent from the remote controller 17, thereby controlling the sections in such a manner that contents due to these information items may be reflected.

In this case, the control section 59 mainly utilizes a read only memory (ROM) 60 in which a control program executed by the CPU is stored, a random access memory (RAM) 61 that provides a working area for this CPU, and a nonvolatile memory 62 in which various kinds of set information, control information, etc. are stored.

Further, this control section 59 is connected via a card interface (I/F) 63 to a card holder 64 which the above-described first memory card 19 can be attached to and detached from. Accordingly, the control section 59 can transfer information through the card I/F63 and the first memory card 19 attached to the card holder 64.

Moreover, this control section 59 is connected via a card I/F65 to a card holder 66 which the above-described second memory card 20 can be attached to and detached from. Accordingly, the control section 59 can transfer information through the card I/F65 and the second memory card 20 attached to the card holder 66.

Further, this control section 59 is connected via a communication I/F67 to the first LAN terminal 21. Accordingly, the control section 59 can transfer information through the communication I/F67 and the LAN-compliant HDD25 connected to the first LAN terminal 21. In this case, the control section 59 has a dynamic host configuration protocol (DHCP) server function, to conduct control by assigning an Internet protocol (IP) address to the LAN-compliant HDD25 connected to the first LAN terminal 21.

Moreover, this control section 59 is connected via a communication I/F68 to the second LAN terminal 22. Accordingly, the control section 59 can transfer information through the communication I/F68 and any one of the various apparatuses (see FIG. 1) connected to the second LAN terminal 22.

Further, this control section 59 is connected to the above-described USB terminal 23 via a USB I/F69. Accordingly, the control section 59 can transfer information through the USB I/F69 and any one of the apparatuses (see FIG. 1) connected to the USB terminal 23.

Moreover, this control section 59 is connected to the i.Link terminal 24 via an i.Link I/F70. Accordingly, the control section 59 can transfer information through the i.Link I/F70 and any one of the apparatuses (see FIG. 1) connected to the i.Link terminal 24.

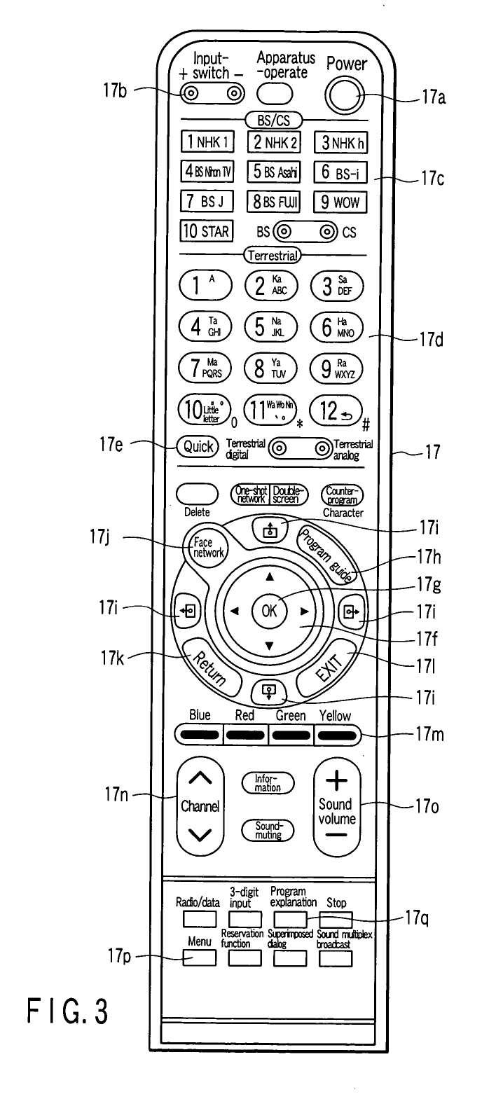

FIG. 3 shows an external view of the remote controller 17. This remote controller 17 is mainly provided with a power key 17a, an input switchover key 17b, a satellite digital broadcast channel direct selection key 17c, a terrestrial broadcast channel direct selection key 17d, a quick key 17e, a cursor key 17f, a OK key 17g, a program guide key 17h, a page switchover key 17i, a face net (navigation) key 17j, a return key 17k, a EXIT key 171, a B-R-G-Y color key 17m, a channel up/down key 17n, a sound volume adjustment key 17o, a menu key 17p, a program explanation key 17q, etc.

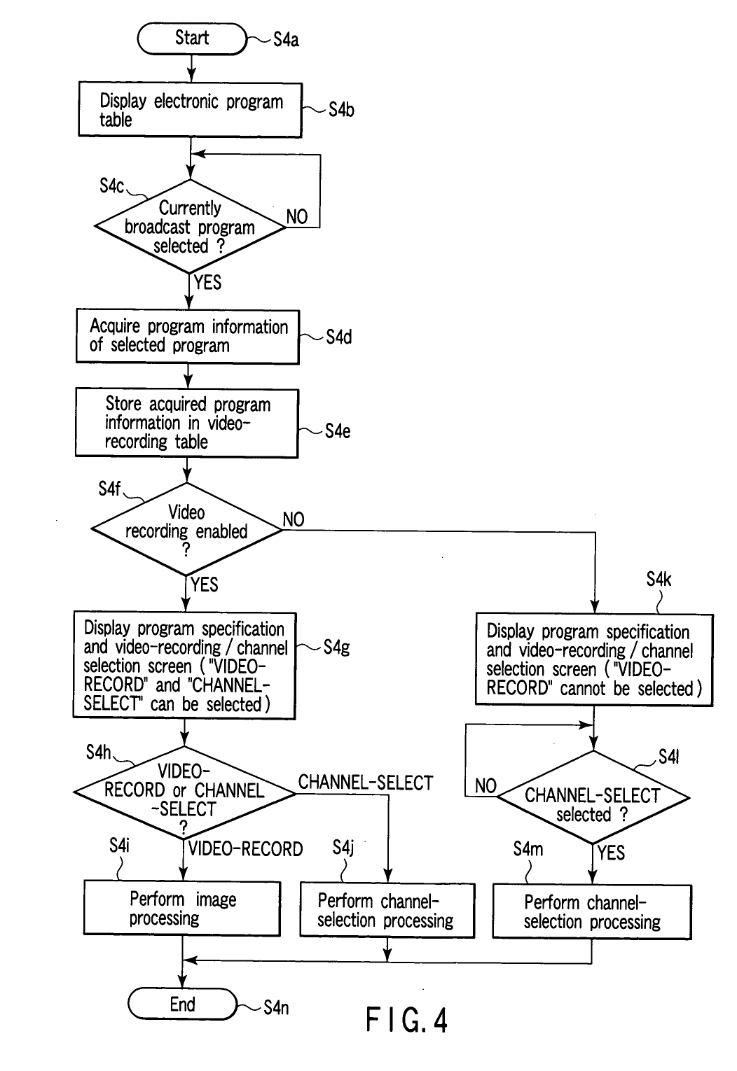

FIG. 4 shows a flowchart of an operation of channel selection or video recording of a program being broadcast currently, by the present digital TV broadcast receiver 11. This operation starts (step S4a) when a user operates the program table key 17h on the remote controller 17.

Then, in step S4b, the control section 59 creates an electronic program table based on EPG information, which is program information acquired beforehand via a broadcast signal, a network, etc., and displays part of it on the video display 14. The part of the electronic program table displayed on this video display 14 is determined on the basis of the last conditions displayed previously such as a channel and date/hour.

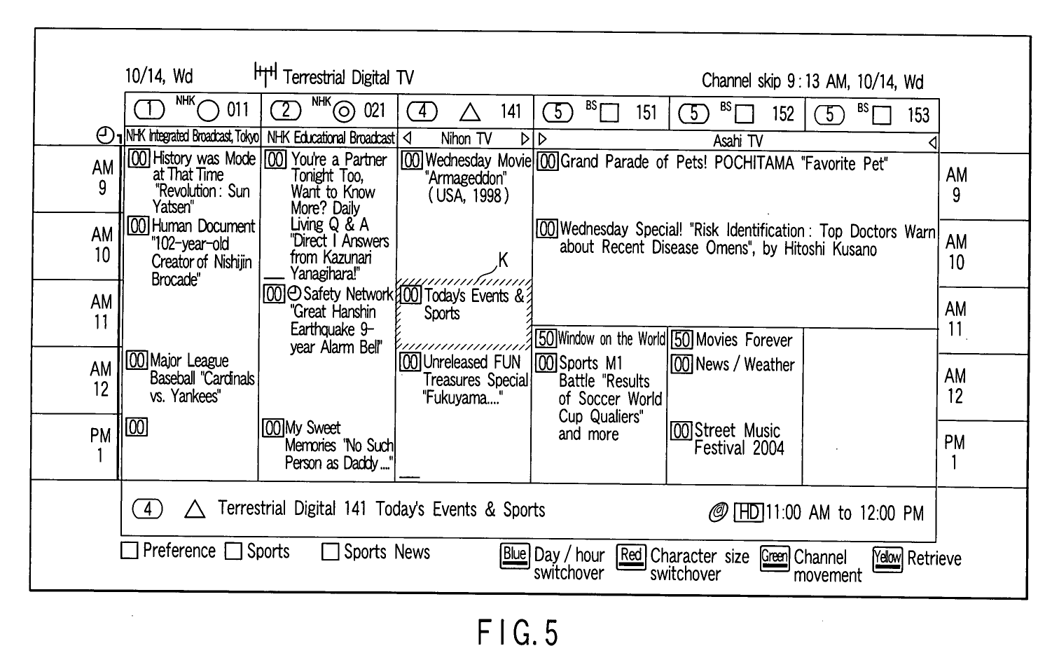

FIG. 5 shows one example of the electronic program table displayed on the video display 14. To display programs, this electronic program table is horizontally divided into six broadcast stations (channels) and vertically divided into five one-hour time frames.

In this electronic program table, each of the programs is selected by using a cursor K. FIG. 5 shows an example of selecting by using the hatched cursor key K a program of “TODAY'S EVENT & SPORTS MAX” to be broadcast by the broadcast station “NIPPON TV” at 11 AM. By moving the cursor K vertically and horizontally by operating the cursor key 17f on the remote controller 17, a desired one of the programs can be selected. In this case, it is possible to selectively scroll the electronic program table vertically and horizontally as the cursor K moves.

In such condition of the electronic program table being displayed, the control section 59 decides in step S4c whether the program being broadcast currently is selected in the electronic program table. This decision of whether it is selected or not is made by judging whether the desired program currently broadcast is selected with the cursor K in the electronic program table and the determination key 17g on the remote controller 17 is operated.

If it is decided that the currently broadcast program is selected in the electronic program table (YES), the control section 59 acquires program information of that selected program in step S4d and stores the acquired program information in a video-recording table stored in the above-described nonvolatile memory 62 in Step 4e. If video recording of the selected program is desired, the control section 59 will perform video recording of that program based on the program information stored in the video-recording table.

Then, in step S4f, the control section 59 decides whether the thus selected program can be video-recorded. Specifically, it is decided, for example, whether a broadcast time slot of the selected program overlaps with that of any other program reserved for video recording, whether the selected program is contracted for reception, whether it is permitted to copy the selected program, or whether conditions are set to restrict video-recording the program.

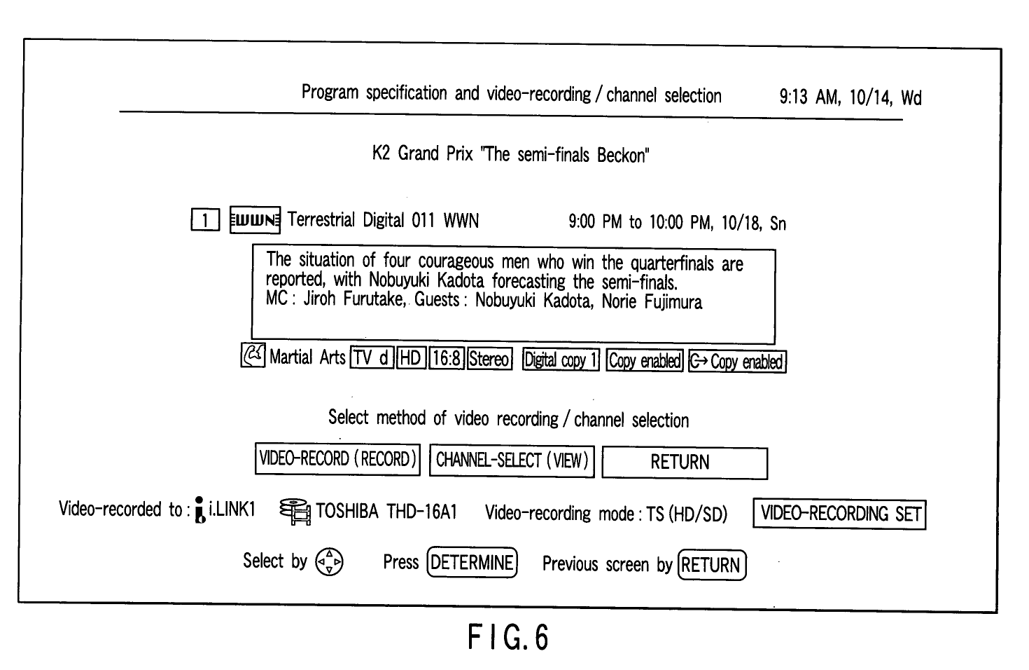

If it is decided that the selected program can be video-recorded (YES), the control section 59 displays the program specification and video-recording/channel selection screen in step S4g. As shown in FIG. 6, this program specification and video-recording/channel selection screen displays a program name, a broadcast station name, a channel, a broadcast day, a broadcast time, outlined explanation of programs, etc. based on the acquired program information of the selected program. It is thus possible for the user to easily confirm the program information of his selected program.

Further, on this program specification and video-recording/channel selection screen, an item of “VIDEO-RECORD (or RECORD)” and an item of “CHANNEL-SELECT (or VIEW)” are displayed in such a manner that they can be selectively selected. Specifically, the cursor key 17f is operated to select either “VIDEO-RECORD” or “CHANNEL-SELECT” and operate the determination key 17g on the remote controller 17.

Then, in step S4h, the control section 59 decides which one of “VIDEO-RECORD” and “CHANNEL-SELECT” is selected on the program specification and video-recording/channel selection screen. If it is decided that the item of “VIDEO-RECOR” is selected, the control section 59 selects the thus selected program being broadcast currently in step S4i, video-records this selected program based on the program information in the video-recording table, and ends the processing (step S4n). In such a manner, a program currently broadcast can be selected and video-recorded.

In this video-recording processing, it is possible to view a selected program currently broadcast as video-recording it and also automatically stop the video-recording at a finish time of the program based on program information.

If it is decided in step S4h that the item of “CHANNEL-SELECT” is selected, on the other hand, the control section 59 performs channel selection processing of that selected program currently broadcast in step S4j and ends the processing (step S4n). In such a manner, a channel of a program currently broadcast can be selected to view the program.

It is to be noted that in this channel selection processing, the channel selection is not automatically stopped even at a finish time of a selected program, to enable the user to continuously view the selected channel of program.

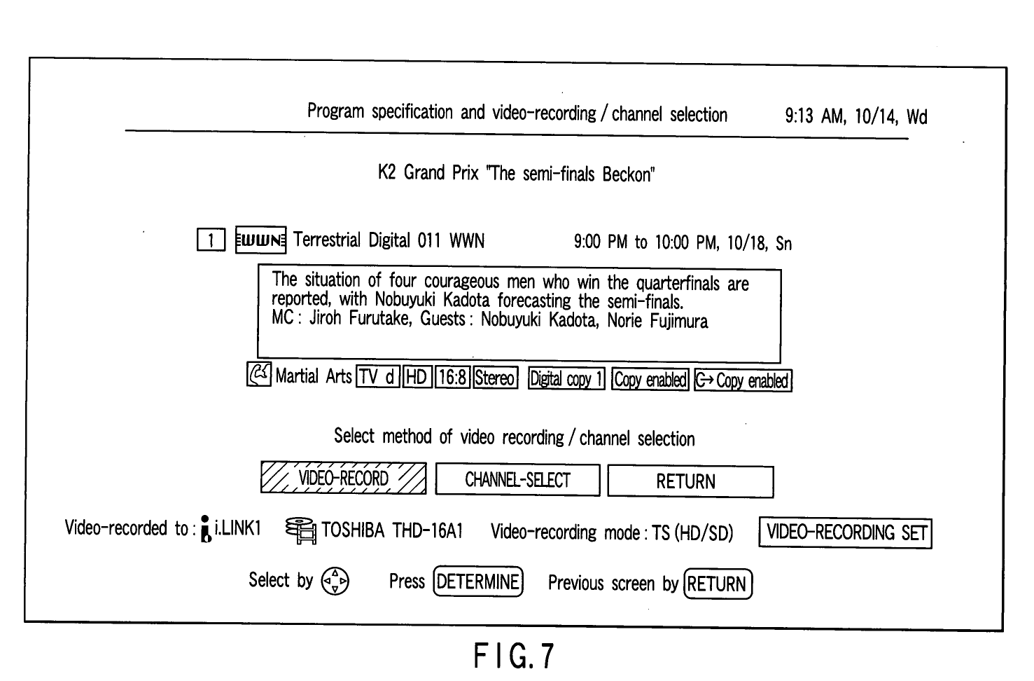

If it is decided at the above-described step S4f that the selected program cannot be video-recorded (NO), on the other hand, the control section 59 displays such a program specification and video-recording/channel selection screen as shown in FIG. 7 in step S4k.

Like that shown in FIG. 6, this program specification and video-recording/channel selection screen displays a program name, a broadcast station name, a channel, a broadcast day, a broadcast time, outlined explanation of programs, etc. based on the acquired program information of the selected program. It is thus possible for the user to easily confirm the program information of his selected program.

However, on this program specification and video-recording/channel selection screen shown in FIG. 7, the item of “VIDEO-RECORD” is displayed in toned-down condition as can be seen from hatching, to notify the user that this item cannot be selected. Further, even if the cursor key 17f on the remote controller 17 is operated actually, it is set that the item of “VIDEO-RECORD” cannot be selected. It is thus possible for the user to recognize that a selected program currently broadcast cannot be video-recorded before performing an operation to request video recording.

If it is decided in step S41 that the item of “CHANNEL-SELECT” is selected (YES), the control section 59 performs channel-selection processing on that selected program currently broadcast in step S4m and ends the processing (step S4n). It is thus possible to select a currently broadcast program and view it.

By this embodiment, first at a point in time when a currently broadcast program is selected in the electronic program table and determined, program information of that program is displayed as a program specification and video-recording/channel selection screen. It is thus possible for the user to easily confirm program information of a selected program.

Further, an operation to decide whether to video-record or select a channel of a selected program can be performed on the program specification and video-recording/channel selection screen, so that the user can easily confirm program information of the program to be video-recorded or whose channel is to be selected by the user.

Furthermore, if it is decided that a selected program cannot be video-recorded, the item of “VIDEO-RECORD” is displayed in toned-down condition on the program specification and video-recording/channel selection screen to notify the user that the program cannot be video-recorded, so that the user can recognize that the selected program currently broadcast cannot be video-recorded before performing an operation to request video recording, thus being facilitated in handling.

In the above step of decision on overlapping of broadcast time slots, there are some cases where in an electronic program table a program reserved for video recording may be displayed on a different mode, for example, in a different color from the other programs. In such a case, the user can look at the electronic program table to recognize whether a broadcast time slot of a selected program currently broadcast overlaps with that of any other program reserved for video recording.

However, since an electronic program table displayed on the screen only in part of it, to know whether a program is reserved for video recording on a portion not shown on the screen, the user needs to scroll and check an entirety of the electronic program table corresponding to a current time instant, thus resulting in troublesome handling for him.

Therefore, as described above, at a point in time when the user selects a currently broadcast program, whether it can be video-recorded is displayed on the program specification and video-recording/channel selection screen that displays program information, to facilitate handling for the user, thereby giving effects that can be practically applied sufficiently.

It is to be noted that it is also possible, in video-recording processing of a program at the above step of S4i, to reproduce that program being video-recorded, that is, perform chasing playback.

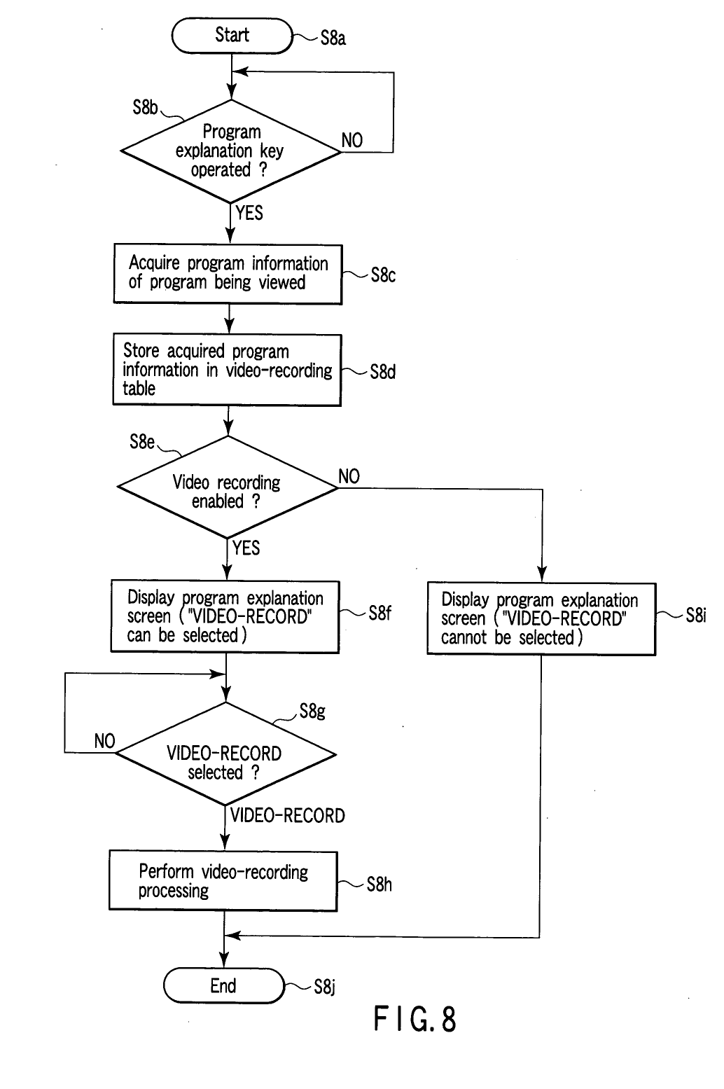

FIG. 8 is a flowchart of an operation of video-recording a currently viewed program in the digital TV broadcast receiver 11 of the present embodiment. This operation starts (step S8a) in condition where a user is viewing a predetermined program being broadcast currently.

Then, the control section 59 decides in step S8b whether the program explanation key 17q is operated on the remote controller 17 and, if such is the case (YES), acquires program information of that currently viewed program in step S8c and stores the acquired program information in a video-recording table stored in the above-described nonvolatile memory 62.

Then, in step S8e, the control section 59 decides whether the currently viewed program can be video-recorded. Specifically, it is decided, for example, whether a broadcast time slot of the selected program overlaps with that of any other program reserved for video recording, whether it is permitted to copy the selected program, or whether conditions are set to restrict video-recording the program.

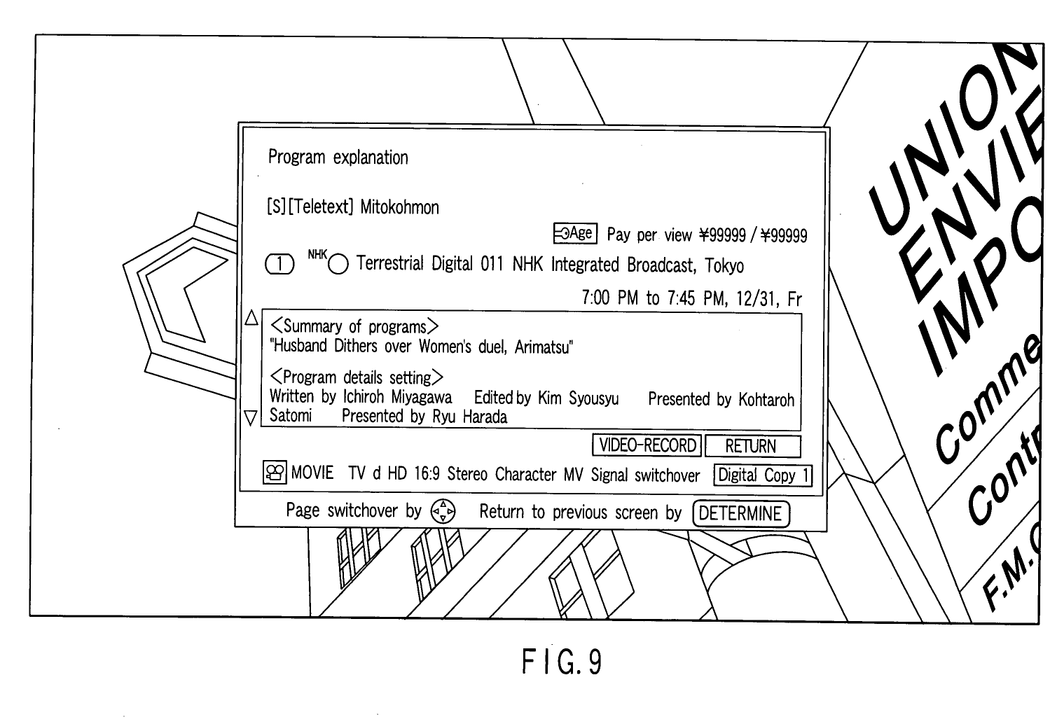

If it is decided that the program being viewed currently can be video-recorded (YES), the control section 59 displays the program explanation screen in Step S8f. This program explanation screen is displayed in condition where it is superimposed on a video of the currently viewed program as shown in FIG. 9, thereby indicating a program name, a broadcast station name, a channel, a broadcast day, a broadcast time, outlined explanation of programs, etc. based on the acquired program information of the currently viewed program. It is thus possible for the user to easily confirm the program information of his selected program.

Further, on this program explanation screen, the item of “VIDEO-RECORD” is displayed. This item of “VIDEO-RECORD” can be selected by operating the cursor key 17f and then the determination key 17g on the remote controller 17.

Then, in step S8g, the control section 59 decides whether the item of “VIDEO-RECORD” is selected on the program explanation screen. If it is decided that the item of “VIDEO-RECORD” is selected (YES), the control section 59 video-records the currently broadcast program based on the program information in the video-recording table in Step S8h and ends the processing (step S8j). It is thus possible to video-record a program currently viewed.

In this video-recording processing, it is possible to video-record a program as viewing it and also automatically stop the video recording at a finish time of the program based on program information. It is to be noted that channel selection is not automatically stopped even at a finish time of a selected program, to enable the user to continuously view the selected channel of program.

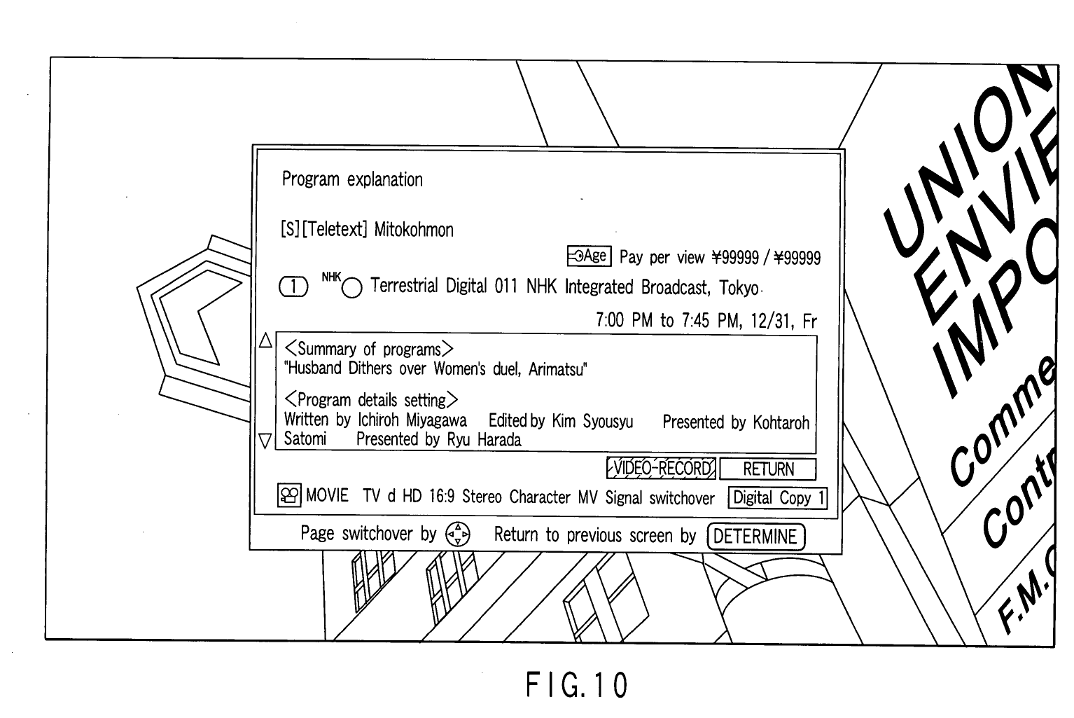

If it is decided at the above-described step S8e that the program being viewed cannot be video-recorded (NO), on the other hand, the control section 59 displays such a program explanation screens as shown in FIG. 10 in step S8i and ends the processing (step S8j).

Like that shown in FIG. 9, this program explanation screen displays a program name, a broadcast station name, a channel, a broadcast day, a broadcast time, outlined explanation of programs, etc. based on the acquired program information of the selected program. It is thus possible for the user to easily confirm the program information of currently viewed program.

However, on the program explanation screen shown in FIG. 10, the item of “VIDEO-RECORD” is displayed in toned-down condition as can be seen from hatching, to notify the user that this item cannot be selected. Further, even if the cursor key 17f on the remote controller 17 is operated actually, it is set that the item of “VIDEO-RECORD” cannot be selected. It is thus possible for the user to recognize that a program being viewed currently cannot be video-recorded before performing an operation to request video recording.

By the operations shown in FIG. 8, by operating the program explanation key 17q on the remote controller 17 in condition where a predetermined program currently broadcast is being viewed, program information of this currently viewed program is displayed. It is thus possible for the user to easily confirm program information of the program being viewed currently.

Further, an operation to video-record a program being viewed can be performed in the program explanation screen, so that the user can easily confirm program information of the program to be video-recorded.

Furthermore, if it is decided that a currently viewed program cannot be video-recorded, the item of “VIDEO-RECORD” is displayed in toned-down condition on the program explanation screen to notify the user that the program cannot be video-recorded, so that the user can recognize that the program currently viewed cannot be video-recorded before performing an operation to request video recording, thus being facilitated in handling.

Further, it is also possible, in video-recording processing of a program at the above step of S8h, to reproduce that program being video-recorded, that is, perform chasing playback.

It is to be noted that the present invention is not limited to the above embodiment as it is and actually can be embodied by variously modifying its components in a scope without departing from its gist. Further, by appropriately combining a plurality of components disclosed in the above embodiment, a variety of inventions can be given. For example, some of the components given in the embodiment can be deleted. Further, some of the components related to a different embodiment may be combined appropriately.

What is claimed is:

1. A program video-recording apparatus comprising:
acquisition sections configured to acquire and store program information of a predetermined program being delivered;
a decision section configured to decide whether a program corresponding to the program information can be video-recorded, based on the program information acquired by the acquisition sections; and
a control section configured to provide display based on the program information acquired by the acquisition sections and display based on a result of decision by the decision section.

2. A program video-recording apparatus according to claim 1, further comprising a selection section configured to select and determine a desired program from among a plurality of programs being delivered, wherein
the acquisition sections are configured to acquire and store the program information of the program selected and determined by the selection section, and the decision section is configured to decide whether the program selected and determined by the selection section can be video-recorded, based on the program information acquired by the acquisition sections.

3. A program video-recording apparatus according to claim 2, wherein the decision section is configured to either:
decide whether a delivery time slot of the program selected and decided by the selection section overlaps with that of any other program reserved for video recording and, if such is not the case, enable video recording of the program selected and determined by the selection section;
decide whether the program selected and determined by the decision section is contracted for reception and, if such is the case, enable video recording of the program selected and determined by the selection section; or
decide whether it is permitted to copy the program selected and determined by the selection section and, if such is the case, enable video recording of the program selected and determined by the selection section.

4. A program video-recording apparatus according to claim 2, wherein the control section is configured to:
if it is decided by the decision section that the program selected and determined by the selection section can be video-recorded, indicate that an operation to request video recording of this program can be performed; and
if it is decided by the decision section that the program selected and determined by the selection section cannot be video-recorded, indicate that an operation to request video recording of this program cannot be performed.

5. A program video-recording apparatus according to claim 2, wherein if it is decided by the decision section that the program selected and determined by the selection section can be video-recorded, the control section is configured to indicate that an operation to request video recording of the program and an operation to select a channel of the program can be performed selectively.

6. A program video-recording apparatus according to claim 2, wherein if it is decided by the decision section that the program selected and determined by the selection section cannot be video-recorded, the control section is configured to indicate that an operation to request video recording of the program cannot be performed and an operation to select a channel of the program can be performed.

7. A program video-recording apparatus according to claim 2, wherein the selection section is configured to select and determine the desired program in the electronic program table created and displayed on the basis of the acquired program information.

8. A program video-recording apparatus according to claim 1, wherein
the acquisition sections are configured to perform a predetermined operation during viewing of a program to thereby acquire and store program information of the program being viewed, and
the decision section is configured to decide whether the program being viewed can be video-recorded on the basis of the program information acquired by the acquisition sections.

9. A program video-recording apparatus according to claim 8, wherein the decision section is configured to either:
decide whether a delivery time slot of the program being viewed overlaps with that of any other program reserved for video recording and, if such is not the case, enable video recording of the program being viewed; or
decide whether it is permitted to copy the program being viewed and, if such is the case, enable video recording of the program being viewed.

10. A program video-recording apparatus according to claim 8, wherein the control section is configured to:
if it is decided by the decision section that the program being viewed can be video-recorded, indicate that an operation to request video recording of this program can be performed; and
if it is decided by the decision section that the program being viewed cannot be video-recorded, indicate that an operation to request video recording of this program cannot be performed.

11. A program video-recording apparatus according to claim 1, comprising a playback section configured to video-record the program decided by the decision section to be able to be video-recorded based on the request for video recording and, during video recording of the program, reproduce a hitherto video-recorded portion of the program in accordance with a play-back request.

12. A program video-recording method comprising:
a first step of acquiring and storing program information of a predetermined program being delivered;
a second step of deciding whether a program corresponding to the program information can be video-recorded, based on the acquired program information; and
a third step of providing display based on the acquired program information and display based on a result of the decision.

13. A program video-recording method according to claim 12, further comprising a fourth step of selecting and determining a desired program from among a plurality of programs being delivered, wherein
the first step acquires and stores the program information of the program selected and determined by the fourth step, and
the second step decides whether the program selected and determined by the fourth step can be video-recorded, based on the program information acquired by the first step.

14. A program video-recording method according to claim 12, wherein
the first step performs a predetermined operation during viewing of a program to thereby acquire and store program information of the program being viewed, and
the second step decides whether the program being viewed can be video-recorded on the basis of the program information acquired by the first step.
